(19) United States
(12) Patent Application Publication
(10) Pub. No.: US 2025/0296674 A1
(43) Pub. Date: Sep. 25, 2025

(54) VARIABLY SWEPT WING ACTUATION IN SMALL FORM FACTOR GUIDED AIRCRAFTS

(71) Applicant: BAE SYSTEMS Information and Electronic Systems Integration Inc., Nashua, NH (US)

(72) Inventors: Tyler Nickerson, Mason, NH (US); Ryan Dippel, Arlington, MA (US); Michael Sirvydas, Manchester, NH (US); Jared B. Foster, Jamaica Plain, MA (US)

(73) Assignee: BAE SYSTEMS Information and Electronic Systems Integration Inc., Nashua, NH (US)

(21) Appl. No.: 18/614,847

(22) Filed: Mar. 25, 2024

(51) Int. Cl. B64C 3/40; F42B 10/14

(52) U.S. Cl. CPC B64C 3/40; F42B 10/14

(57) ABSTRACT

A small form factor aircraft comprising: a body comprising an internal volume; at least one motor disposed within the internal volume; at least one lead screw driven by the at least one motor; at least one collar disposed at least partially within the internal volume of the body; at least one pair of wings, each wing being rotatably attached to the collar adjacent a forward or rear edge; at least one coupler, each coupler being rotatably coupled to a pair of adjacent wings, the coupler comprising a threaded, central section configured to engage with the at least one lead screw such that rotation of the at least one lead screw results in axial translation of the at least one coupler within and relative to the body; and a controller configured to control the at least one motor.

### FIELD OF THE DISCLOSURE

The following disclosure relates generally to aircraft, and, more specifically, to variable sweep wings suitable for use in small form factor aircraft.

### BACKGROUND

Variable sweep wings, which are also sometimes referred to as “swing wings,” are relatively common on aircraft and allow the aircraft's shape to be modified in flight. For example, at high speeds, a high sweep angle may be used to reduce drag and maintain an acceptable static margin while, at lower speeds, a low sweep angle (i.e. more perpendicular to the surface of the body) may be used to provide better stability and/or better control authority. Varying the sweep angle continuously, based on the aircraft's current speed, provides a more finely tuned control regime and performance at all speeds.

While this capability is well researched and relatively common in the context of manned aircraft, especially jet fighters, this is not the case with smaller aircraft, such as 2.75″-7″ missiles, which typically use wings that flip out by 90-degrees after launch, often from a tube, and remain static during flight. This design is used due to packaging, efficiency, and weight issues that are particularly acute at this scale and that prevent the use of traditional, hydraulic control systems.

Furthermore, while an infinitely-variable swept wing is known to increase efficiency on relatively large aircraft, existing infinitely-variable swept wing systems decrease efficiency on smaller aircraft due to increased drag and/or weight attributable to the system. These issues are particularly acute in the case of missiles, especially relatively small, tube-launched missiles, since these typically fly a short distance and at a relatively constant speed following an initial acceleration, resulting in fewer operating regimes and less time spent in each in which to optimize flight characteristics and obtain a benefit from such a system.

These considerations make an efficient design critical to feasibility. Suitable designs for enabling a variable-sweep wing system, however, are limited as any design must be non-reciprocal; air pressure on a front of a wing cannot be allowed to back feed into the system. On larger aircraft, hydraulic systems, which are typically already present and used to control the aircraft's control surfaces, can be used, as back feed resistance is inherent in such systems so long as hydraulic pressure is maintained. In a typical small aircraft or missile, however, no such system is present and to include one to drive only the wing sweep would not be efficient in terms of weight or space needed, necessitating an alternative design.

Accordingly, there is a need for a compact, space and weight efficient, non-reciprocal and back feed resistant design for incorporating a variably swept wing into a small form factor aircraft, such as a missile.

### SUMMARY

A system allowing any number of wings, especially those on a relatively small aircraft, such as a missile, to infinitely and adaptively variably sweep is disclosed herein.

In embodiments, the mechanism uses a lead screw to deploy wings and/or control surfaces radially, requires no linear actuators, and provides a mechanical advantage for motors, such as low SWAP-C stepper or servo motors, which can be flexibly mounted within an aircraft, allowing them to be located in dead space present in existing designs.

The use of a lead screw mechanism effectively prevents back feed, requiring little to no holding torque from the motors, since such mechanisms are inherently non-reciprocal, reducing the size of motor and quantity of fuel and/or size of batteries needed. Notably, even if the lead screw mechanism is back driven, this will occur at a somewhat controlled rate, since the friction in the assembly, the lead angle, and the inefficiency of the screw all must be overcome. This design also eliminates other components from the aircraft, for example springs, latches, and squibs that are currently used to deploy wings, freeing up internal space while reducing weight and complexity.

Importantly, the use of radially deployed wings (wings that rotate from a forward or rear edge of a wingtip, with the front or rear rotating out) allows the aircraft to be launched from a tube, since tube launched aircraft are unable to utilize fixed wings.

One embodiment of the present disclosure provides a small form factor aircraft comprising: a body comprising an internal volume; at least one motor disposed within the internal volume; at least one lead screw driven by the at least one motor; at least one collar disposed at least partially within the internal volume of the body; at least one pair of wings, each wing being rotatably attached to the collar adjacent a forward or rear edge; at least one coupler, each coupler being rotatably coupled to a pair of adjacent wings, the coupler comprising a threaded, central section configured to engage with the at least one lead screw such that rotation of the at least one lead screw results in axial translation of the at least one coupler within and relative to the body; and a controller configured to control the at least one motor, wherein the at least one motor and at least one collar are fixed in position with respect to the body, wherein the rotatable coupling between adjacent wings is inboard of the rotatable attachment point between each wing and the collar, and wherein the at least one pair of wings is configured to sweep from the body about the rotatable attachment point between each wing and the collar in a substantially planar manner.

Another embodiment of the present disclosure provides such a small form factor aircraft, wherein the controller is configured to deploy the at least one set of wings and/or at least one set of control surfaces to a high sweep angle at high speeds, a low sweep angle at low speeds, and a medium sweep angle at medium speeds.

Yet another embodiment of the present disclosure provides such an aircraft, wherein the at least one set of wings and/or control surfaces are rotatably attached to the body adjacent a forward edge.

A yet further embodiment of the present disclosure provides such an aircraft, wherein the at least one set of wings and/or control surfaces are rotatably attached to the body adjacent a forward edge.

Still another embodiment of the present disclosure provides such an aircraft, wherein the aircraft is a missile.

A still further embodiment of the present disclosure provides such an aircraft, wherein the aircraft has a body diameter of between 2.75″-7″.

Even another embodiment of the present disclosure provides such an aircraft, wherein the at least one motor is a rotary electric motor.

An even further embodiment of the present disclosure provides such an aircraft, wherein the at least one motor is a stepper motor.

A still even further embodiment of the present disclosure provides such an aircraft, wherein the at least one motor is a servo motor.

A still even another embodiment of the present disclosure provides such an aircraft, wherein the at least one set of wings additionally comprise control surfaces and are configured to be controlled by the controller and to effect a change in orientation of the body while in motion.

A still even further embodiment of the present disclosure provides such an aircraft comprising wherein the control surfaces comprise tail fins.

Still yet another embodiment of the present disclosure provides such an aircraft, wherein the at least one set of wings are configured to sweep out from substantially within the internal volume to a 90-degree angle relative to a longest-axis of the internal volume.

A still yet further embodiment of the present disclosure provides such an aircraft, further comprising an airspeed sensor, wherein the controller is configured to determine speed using the airspeed sensor.

Even yet another embodiment of the present disclosure provides such an aircraft, wherein the controller is configured to determine speed based on engine burn time.

Still even yet another embodiment of the present disclosure provides such an aircraft, wherein the controller is configured to determine speed based on time since launch.

One embodiment of the present disclosure provides an actuation mechanism for deploying wings of a small form factor aircraft, the actuation mechanism comprising: at least one collar; at least one pair of wings, each wing being rotatably attached to the collar adjacent a forward or rear edge; at least one coupler, each coupler being rotatably coupled to a pair of adjacent wings, the coupler comprising a threaded, central section; and at least one lead screw driven by at least one motor; wherein the at least one lead screw is configured to engage with the threaded, central section of at least one coupler, such that rotation of the one lead screw results in the collar axially traversing the lead screw; and a controller configured to control the at least one motor, wherein the rotatable coupling between adjacent wings is inboard of the rotatable attachment point between each wing and the collar, and wherein the at least one pair of wings is configured to sweep from the body about the rotatable attachment point between each wing and the collar in a substantially planar manner.

Another embodiment of the present disclosure provides such an actuation mechanism, wherein the controller is configured to deploy the at least one set of wings and/or at least one set of control surfaces to a high sweep angle at high speeds, a low sweep angle at low speeds, and a medium sweep angle at medium speeds.

Even another embodiment of the present disclosure provides such an actuation mechanism, further comprising an airspeed sensor, wherein the controller is configured to determine airspeed using the airspeed sensor.

Yet another embodiment of the present disclosure provides such an actuation mechanism, wherein the controller is configured to determine speed based on engine burn time.

One embodiment of the present disclosure provides a missile having infinitely variable sweep wings, the missile comprising: a body comprising an internal volume; at least one motor disposed within the internal volume; at least one lead screw driven by the at least one motor; at least one collar disposed at least partially within the internal volume of the body; at least one pair of wings, each wing being rotatably attached to the collar adjacent a forward or rear edge; at least one coupler, each coupler being rotatably coupled to a pair of adjacent wings, the coupler comprising a threaded, central section configured to engage with the at least one lead screw such that rotation of the at least one lead screw results in axial translation of the at least one coupler within and relative to the body; and a controller configured to control the at least one motor, wherein the at least one motor and at least one collar are fixed in position with respect to the body, wherein the rotatable coupling between adjacent wings is inboard of the rotatable attachment point between each wing and the collar, and wherein the at least one pair of wings is configured to sweep from the body about the rotatable attachment point between each wing and the collar in a substantially planar manner.

Implementations of the techniques discussed above may include a method or process, a system or apparatus, a kit, or a computer software stored on a computer-accessible medium. The details or one or more implementations are set forth in the accompanying drawings and the description below. Other features will be apparent from the description and drawings, and form the claims.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is a side elevation view of a small form factor aircraft with radially-deployable wings, in accordance with embodiments of the present disclosure;

FIG. 2 is a side elevation view of the small form factor aircraft of FIG. 1 with boundaries of the body thereof drawn in dashed lines, showing internal details of a mechanism that uses a lead screw to deploy the wings radially, in accordance with embodiments of the present disclosure;

FIGS. 3A and 3B are isometric views of the mechanism shown in FIG. 2, which is shown separately from the small form factor aircraft, with the wings shown in a stowed configuration;

FIGS. 4A and 4B are isometric views of the mechanism shown in FIGS. 2, 3A, and 3B, which is shown separately from the small form factor aircraft, with the wings shown in a deployed configuration;

FIGS. 5A and 5B are isometric views of the mechanism shown in FIGS. 2, 3A, 3B, 4A, and 4B, which is shown within a sectioned portion of a body of the small form factor aircraft, with the wings shown in FIG. 5A in a stowed configuration and FIG. 5B showing the wings in a deployed configuration; and

FIG. 6 is a detail view showing aspects of the mechanism shown in FIGS. 2, 3A, 3B, 4A, 4B, 5A, and 5B.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

A compact, space and weight efficient, non-reciprocal, and back feed resistant design for incorporating infinitely variably-swept wings into small form factor aircraft 100, such as missiles, is taught herein. The design utilizes at least one lead screw 204 to deploy wings 102 and/or control surfaces 108 radially, requires no linear actuators, provides a mechanical advantage for motors 206, such as low SWAP-C stepper or servo motors, and can be mounted in dead space present in an internal volume 200.

While the embodiments disclosed herein are described in the context of a small form factor aircraft 100 including a mid-body guidance kit (Control Actuation System (CAS)), the design could easily be adapted to a tail-kit or nose-kit aircraft, with tail and nose describing the location of the CAS, or other small form factor aircraft 100.

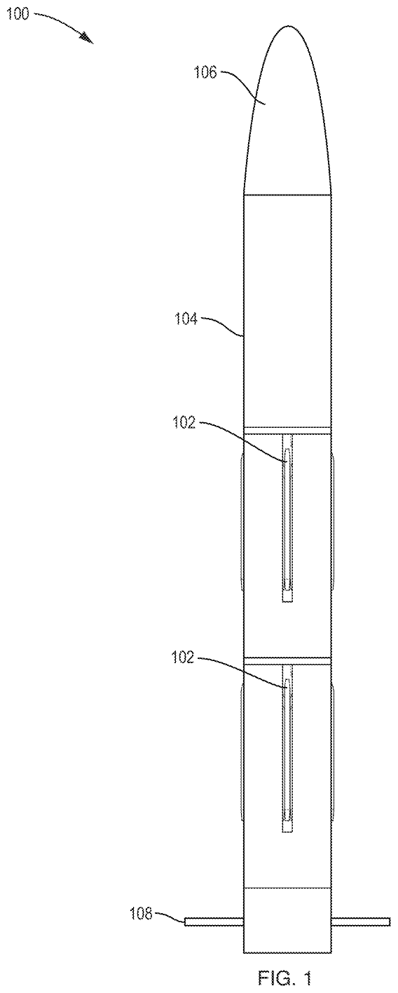

Now referring specifically to FIG. 1, a small form factor aircraft 100 in accordance with embodiments of the present disclosure is depicted. The small form factor aircraft 100 comprises a body 104 having a nose 106, wings 102, and control surfaces 108, which are tail fins in the embodiment depicted. The wings 102 are depicted in a stowed state, i.e. prior to deployment, in which they are substantially contained within the body 104 of the small form factor aircraft 100. A portion of the wing 102 may protrude from the body 104 in embodiments so long as it is aerodynamically insignificant and does not interfere with tube-launch, where applicable. Furthermore, the control surfaces 108 may be incorporated into the wings 102, as is commonly done on larger aircraft. Alternatively, the wings 102 themselves may also function as control surfaces 108.

In embodiments, the small form factor aircraft 100 is a missile, for example a tube launched missile, which may be guided or unguided, with a body 104 diameter of between 2.75″-7″.

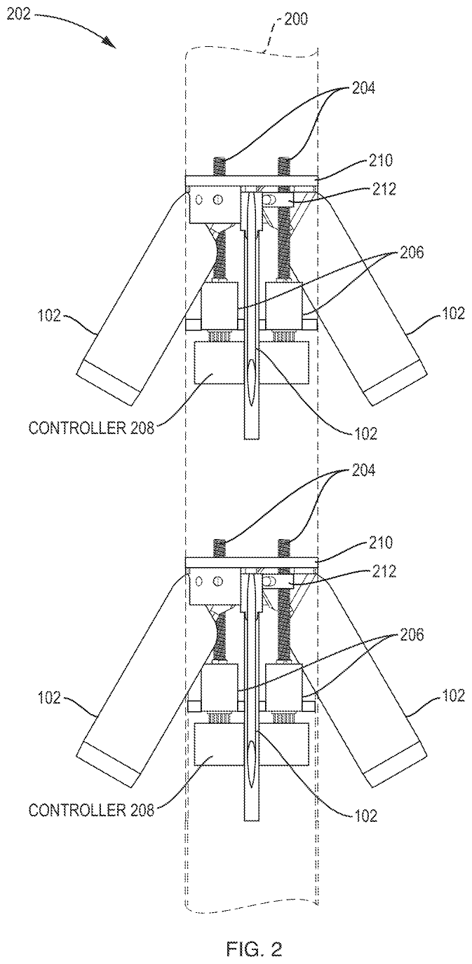

As shown in FIG. 2, the small form factor aircraft 100 comprises an internal volume 200, which houses at least one actuation mechanism 202, each actuation mechanism 202 being configured to radially deploy at least one pair of wings 102 disposed opposite one another in a substantially planar manner, i.e. with each wing rotating about a pivot point disposed in a leading or trailing edge of the each wing 102, such that tips of each wings 102 trace arcs of the same circle, the circle being situated in a single plane, allowing for slop in the system and flex that might be encountered during use.

The actuation mechanism 202 of embodiments comprises at least one lead screw 204 driven by at least one motor 206, which may be a rotary electric motor, such as a servo or stepper motor. Each lead screw is engaged with at least one coupler 212 comprising a threaded, central section configured to engage with the lead screw(s) 204 and to result in axial translation of the coupler 212 in response to rotation of the lead screw 204 with which it is engaged. The motor(s) 206 may be controlled by a controller 208.

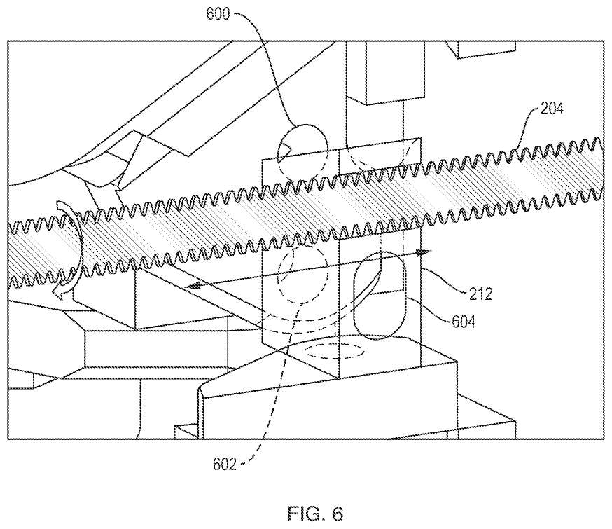

The coupler 212 may be further coupled to wings 102 and/or control surfaces 108, for example through the use of a coupler pivot 602 disposed in the wing 102 or control surface 108 that is aligned with an elongated bore 604 disposed in the coupler 212, where the coupler pivot 602 is sized to accept a pin, which may be press fit, and the elongated bore 604 is sized to accept a portion of the same pin, while allowing for limited inboard and outboard movement of the pin, relative to the collar 212, as shown in FIG. 6. The wings 102 and/or control surfaces 108 are then additionally rotatably coupled to the collar 210, in embodiments using a pin, which may be press fit, that extends between wing pivot 600 and a similarly sized aperture disposed in the collar 210, with the wing pivot 600 disposed outboard of the coupler pivot 602. The collar 210 itself is fixed in position, with respect to the body 104, while the couplers 212 are configured for axial translation within and relative to the body 104 in response to the rotation of lead screws 204 with which they are engaged. This arrangement causes the wings 102 and/or control surfaces 108 to rotate about the wing pivot 600, or sweep, in response to movement of the lead screw 204 caused by the motor(s) 206. The amount of sweep for a given rotation of the lead screw 204 and torque required can be fine tuned by adjusting the distance between the wing pivot 600 and coupler pivot 602.

As depicted in FIG. 6, each coupler 212 is free to translate axially, based on the movement of a lead screw 204 it is engaged with, but cannot rotate relative to the body 104 due to the wing pivots 600 that couple the coupler 212 to a pair of adjacent wings 102 and the and coupler pivots 602 that connect those adjacent wings to the collar 210, which is fixed to the body 104, and restrict the couplers 212 themselves from rotation.

In embodiments, one side of a pinned joint is press fit while the other is relatively looser, enabling rotation between the pinned components while securing them in their respective positions.

In embodiments, the forces and friction encountered in the rotatable joints (wing pivot 600 and coupler pivot 602) during operation are accommodated by tightly-controlled surface finish requirements and/or surface finishes/treatments, such as nitriding, nickel boron coating, electroplating, hardening, and the like.

Alternative ways of rotatably attaching the couplers 212 to the wings 102, control surfaces 108, and/or body 104 of the small form factor aircraft 100, such as bolted connections utilizing bushings to allow for rotation about a discrete axis, could also be used, as would be apparent to one of ordinary skill in the art.

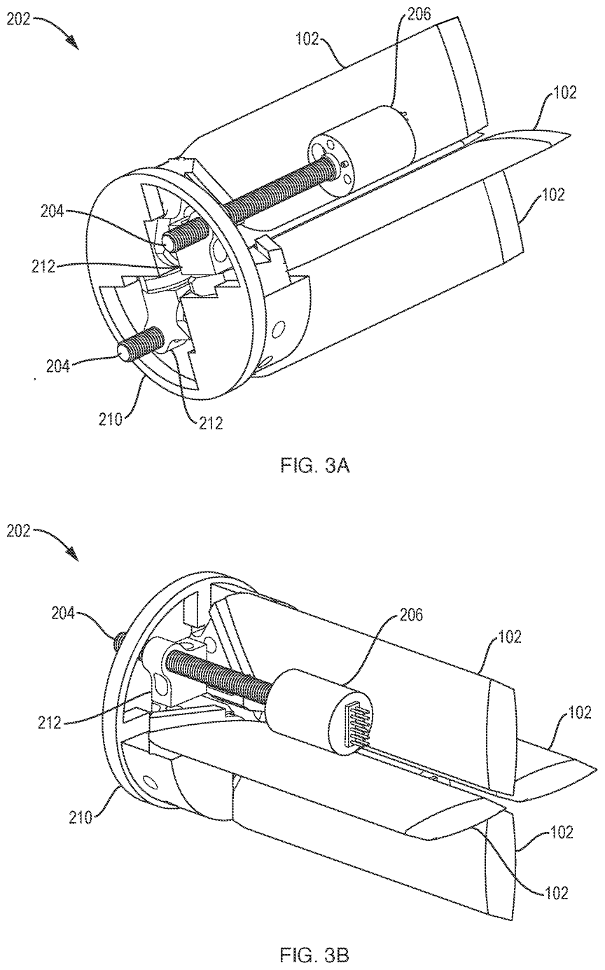

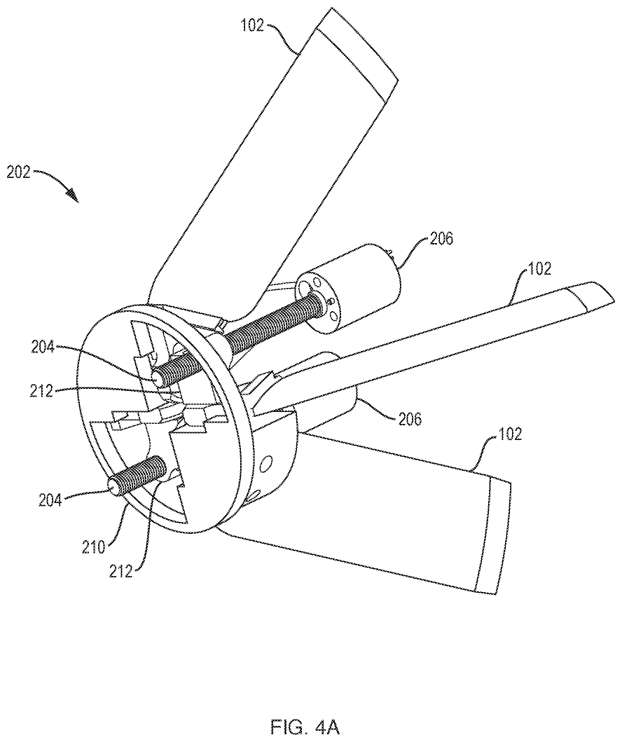

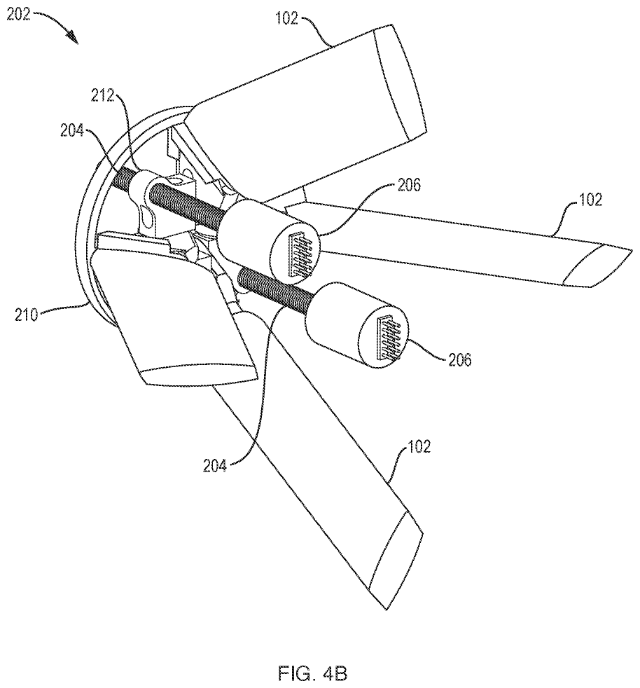

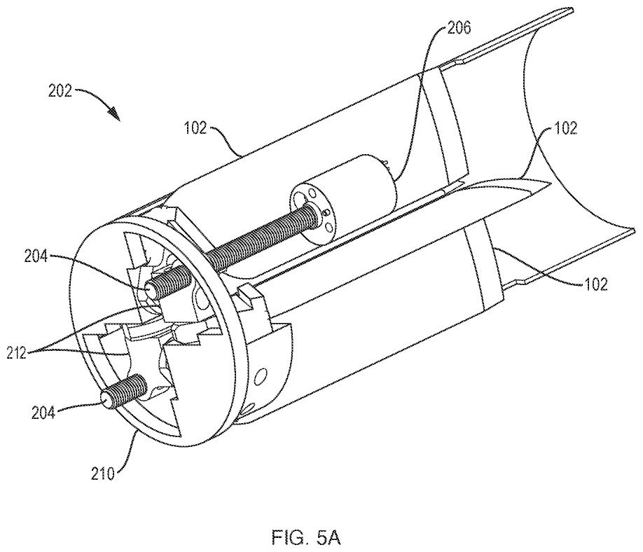

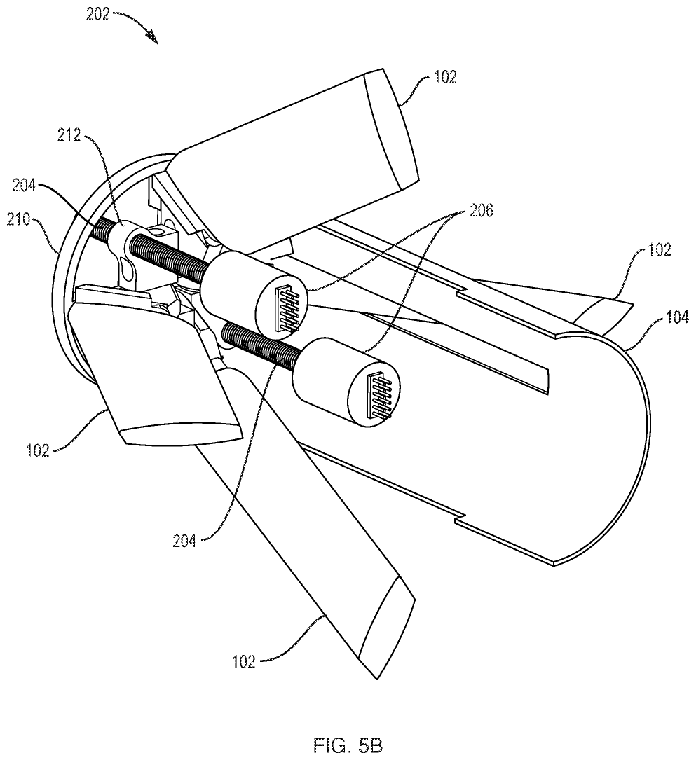

In embodiments, such as those depicted in FIGS. 3A, 3B, 4A, 4B, 5A, and 5B, multiple motors 206 are used in conjunction with a single collar 210 in a side-by-side configuration, with each motor 206 being used to drive a single coupler 212 and each coupler 212 driving a pair of adjacent wings 102.

Each motor 206 may be fastened to the body 104 and/or a downwardly-extending portion of the collar 210 from the side, as depicted in FIG. 2. Alternatively or additionally, the motor(s) may be affixed to the body 104 and/or collar 210 via mounting surfaces machined into a top portion the motor(s) 206 themselves, such as the apertures shown in FIGS. 3A, 4A, and 5A.

In embodiments, the wings 102 and/or control surfaces 108 are hingedly fixed to the collar(s) 210, which are contained at least partially within the internal volume 200 of the body 104 of the small form factor aircraft 100, at a front, inner edge of the wings 102 and/or control surfaces 108. Inboard of the hinged connection to the collar 210, a coupler 212 is hingedly fixed to the wings 102 and engaged with at least one lead screw 204. This arrangement results in a longitudinal translation of the coupler(s) 212 within the body 104 of the small form factor aircraft 100 upon activation of the motor(s) 206, which causes the rotation of the lead screw 204 and results in the wings 102 and/or control surfaces 108 being brought into an orthogonal relationship with the body 104 of the small form factor aircraft 100 at a forwardmost limit. In embodiments, a more limited range of sweep angles may be used, however.

In embodiments, the wings 102 and/or control surfaces 108 are reversed from the configuration described above, being hingedly fixed to the coupler(s) 212, which are contained within the internal volume 200 of the body 104 of the small form factor aircraft 100 at a rear, inner edge. This arrangement results in a longitudinal translation of the coupler(s) 212 within the body 104 of the small form factor aircraft 100 upon activation of the motor(s) 206, causing the rotation of the lead screw 204, which results in the wings 102 and/or control surfaces 108 being brought into an orthogonal relationship with the body 104 of the small form factor aircraft 100 at a rearmost limit.

In embodiments, multiple collars 210, couplers 212, and motors 206 are used, in some cases in stacked configuration, one on top of the other.

In embodiments, each coupler rides along a linear rail disposed within the internal volume 200 to restrain the coupler from lateral load.

In embodiments, the controller 208 is configured to deploy the wings 102 at various sweep angles depending on the speed and/or required maneuverability of the small form factor aircraft 100, in embodiments using an optimizing algorithm. For example, high, medium, and low sweep angles may be used. Sweep angle variation may be infinitely variable within these ranges or stepwise between ranges and what is meant by high, medium, and low will vary significantly depending on the design of the small form factor aircraft 100. For example, a fin size is largely correlated to an axial position of control surfaces relative to the center of gravity, and at these different longitudinal locations different aerodynamic effects are present due to both supersonic and subsonic body coupling. Additionally, the percentage of wing to flaperon area for control surfaces affixed to wings, fin area for control surfaces which are entirely actuated, and the planform shape of either type of control architecture will necessitate different wing sweep angles. Therefore, a given design may have low/mid/high sweep angles which only vary from 0 to 30 degrees or sweep angles which must vary from 15-85 degrees, etc.

In the specific design highlighted in the figures, an appropriate sweep angle would vary between 90 (fully stowed) and 0 degrees (fully perpendicular to the body 104), in part because the missile legacy design is tube launched and the expected ballistics are such that maximum maneuverability at minimum speed would drive at least some maximum weapon capabilities. In this case low/mid/high would be considered 0-30 degrees, 30-60 degrees, and 60-90 degrees, respectively.

In embodiments, determination of speed is accomplished using an airspeed sensor, a GPS receiver, externally-provided data, or the like. In embodiments, speed is estimated by the controller 208 based on engine burn time, time since launch, or in other ways, as would be apparent to one of ordinary skill in the art.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

What is claimed is:

1. A small form factor aircraft comprising:
a body comprising an internal volume;
at least one motor disposed within the internal volume;
at least one lead screw driven by the at least one motor;
at least one collar disposed at least partially within the internal volume of the body;
at least one pair of wings, each wing being rotatably attached to the collar adjacent a forward or rear edge;
at least one coupler, each coupler being rotatably coupled to a pair of adjacent wings, the coupler comprising a threaded, central section configured to engage with the at least one lead screw such that rotation of the at least one lead screw results in axial translation of the at least one coupler within and relative to the body; and
a controller configured to control the at least one motor,
wherein the at least one motor and at least one collar are fixed in position with respect to the body,
wherein the rotatable coupling between adjacent wings is inboard of the rotatable attachment point between each wing and the collar, and
wherein the at least one pair of wings is configured to sweep from the body about the rotatable attachment point between each wing and the collar in a substantially planar manner.

2. The small form factor aircraft of claim 1, wherein the controller is configured to deploy the at least one set of wings and/or at least one set of control surfaces to a high sweep angle at high speeds, a low sweep angle at low speeds, and a medium sweep angle at medium speeds.

3. The small form factor aircraft of claim 1, further comprising an airspeed sensor, wherein the controller is configured to determine airspeed using the airspeed sensor.

4. The small form factor aircraft of claim 2, wherein the controller is configured to determine speed based on engine burn time.

5. The small form factor aircraft of claim 1, wherein the controller is configured to determine speed based on time since launch.

6. The small form factor aircraft of claim 1, wherein the aircraft has a body diameter of between 2.75″-7″.

7. The small form factor aircraft of claim 1, wherein the at least one motor is a rotary electric motor.

8. The small form factor aircraft of claim 1, wherein the at least one motor is a stepper motor.

9. The small form factor aircraft of claim 1, wherein the at least one motor is a servo motor.

10. The small form factor aircraft of claim 1, wherein the at least one set of wings additionally act as control surfaces and are configured to be controlled by the controller and to effect a change in orientation of the body while in motion.

11. The small form factor aircraft of claim 1, further comprising control surfaces.

12. The small form factor aircraft of claim 1, wherein the at least one set of wings are configured to sweep out from substantially within the internal volume to a 90-degree angle relative to a longest-axis of the internal volume.

13. The small form factor aircraft of claim 1, wherein the aircraft is selected from the group consisting of guided missiles, unguided missiles, and drones.

14. The small form factor aircraft of claim 1, wherein the at least one set of wings are rotatably attached to the collar adjacent a forward edge.

15. The small form factor aircraft of claim 1, wherein the at least one set of wings are pivotably attached to the collar adjacent a rear edge.

16. An actuation mechanism for deploying wings of a small form factor aircraft, the actuation mechanism comprising:
at least one collar;
at least one pair of wings, each wing being rotatably attached to the collar adjacent a forward or rear edge;
at least one coupler, each coupler being rotatably coupled to a pair of adjacent wings, the coupler comprising a threaded, central section; and
at least one lead screw driven by at least one motor;
wherein the at least one lead screw is configured to engage with the threaded, central section of at least one coupler, such that rotation of the one lead screw results in the collar axially traversing the lead screw; and
a controller configured to control the at least one motor,
wherein the rotatable coupling between adjacent wings is inboard of the rotatable attachment point between each wing and the collar, and
wherein the at least one pair of wings is configured to sweep from the body about the rotatable attachment point between each wing and the collar in a substantially planar manner.

17. The actuation mechanism of claim 16, wherein the controller is configured to deploy the at least one set of wings and/or at least one set of control surfaces to a high sweep angle at high speeds, a low sweep angle at low speeds, and a medium sweep angle at medium speeds.

18. The actuation mechanism of claim 16, further comprising an airspeed sensor, wherein the controller is configured to determine airspeed using the airspeed sensor.

19. The actuation mechanism of claim 16, wherein the controller is configured to determine speed based on engine burn time.

20. A missile having infinitely variable sweep wings, the missile comprising:
a body comprising an internal volume;
at least one motor disposed within the internal volume;
at least one lead screw driven by the at least one motor;
at least one collar disposed at least partially within the internal volume of the body;
at least one pair of wings, each wing being rotatably attached to the collar adjacent a forward or rear edge;
at least one coupler, each coupler being rotatably coupled to a pair of adjacent wings, the coupler comprising a threaded, central section configured to engage with the at least one lead screw such that rotation of the at least one lead screw results in axial translation of the at least one coupler within and relative to the body; and
a controller configured to control the at least one motor,
wherein the at least one motor and at least one collar are fixed in position with respect to the body,
wherein the rotatable coupling between adjacent wings is inboard of the rotatable attachment point between each wing and the collar, and
wherein the at least one pair of wings is configured to sweep from the body about the rotatable attachment point between each wing and the collar in a substantially planar manner.
